(19) United States
(12) Patent Application Publication
(10) Pub. No.: US 2004/0119440 A1
(43) Pub. Date: Jun. 24, 2004

(54) METHOD FOR SUPPLYING EXTERNAL ELECTRICITY BY A SOLAR BATTERY

(76) Inventor: Ching-Chi Cheng, Taoyuan City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/325,261

(22) Filed: Dec. 19, 2002

(51) Int. Cl. H02J 7/00

(52) U.S. Cl. 320/101

(57) ABSTRACT

A method for supplying eternal electricity comprises activating a light source by an external power source for impinging light on a solar cell so as to convert the radiant energy of the light into an electric power; supplying a portion of the electric power to the light source for continuous illumination while cutting off the external power source for forming an everlasting power generation; and supplying a remained portion of the electric power to a perpetual battery as a source of eternal power supply. Preferably, the light source is an incandescent lamp, electroluminescent lamp, or light-emitting diode (LED).

### FIELD OF THE INVENTION

The present invention relates to solar batteries and more particularly to a method for supplying eternal electricity by a solar celled perpetual battery.

### BACKGROUND OF THE INVENTION

Electricity is closely related to our daily life and work. For example, an activation of any of lamps, domestic appliances, cellular phones, computers, motor vehicles, etc. is made possible only through a supply of electricity. It is also understood that electricity is consumed significantly in a use state of any of the above devices. Hence, a charging or replacement of used cells is frequent. This is inconvenient. For solving this problem, a variety of techniques have been proposed. One of them is the utilization of solar energy for providing a clean, inexpensive, and eternal energy source. However, the prior art techniques can only achieve one or two of the above goals. Thus, continuing improvements in the exploitation of solar energy are constantly being sought.

### SUMMARY OF THE INVENTION

It is therefore an object of the present invention to provide a method for supplying eternal electricity comprising the steps of activating a light source by an external power source for impinging light on a solar cell so as to convert the radiant energy of the light into an electric power; supplying a portion of the electric power to the light source for continuous illumination while cutting off the external power source for forming an everlasting power generation; and supplying a remained portion of the electric power to a perpetual battery as a source of eternal power supply.

In one aspect of the present invention, the light source is one of incandescent lamp, electroluminescent lamp, and light-emitting diode (LED).

The above and other objects, features and advantages of the present invention will become apparent from the following detailed description taken with the accompanying drawings.

### BRIEF DESCRIPTION OF THE DRAWINGS

FIG. 1 is a flow chart illustrating a process according to the invention; and

FIG. 2 is a cross-sectional view of a perpetual battery for supplying eternal electricity according to the invention.

### DETAILED DESCRIPTION OF THE PREFERRED EMBODIMENTS

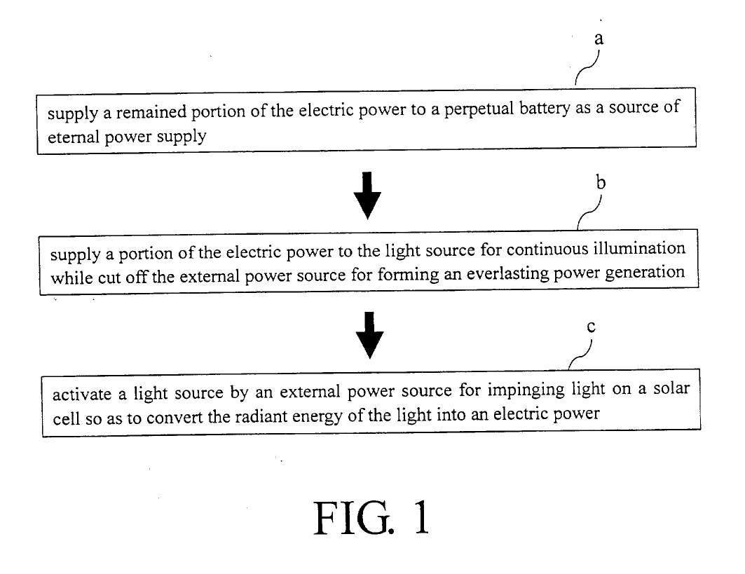

Referring to FIG. 1, there is shown a process in accordance with the invention comprising the steps of (a) activating a light source by an external power source for impinging light on a solar cell so as to convert the radiant energy of the light into an electric power; (b) supplying a portion of the electric power to the light source for continuous illumination while cutting off the external power source for forming an everlasting power generation; and (c) supplying a remained portion of the electric power to a perpetual battery as a source of eternal power supply.

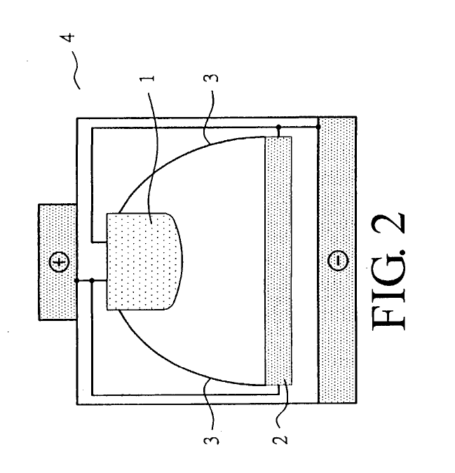

Referring to FIG. 2, there is shown a perpetual battery 4 of the invention. The perpetual battery 4 is a container. Within the perpetual battery 4, there are provided an upper light source (e.g., incandescent lamp, electroluminescent lamp, light-emitting diode (LED), etc.) 1 activated by an external power source (not shown) for emitting light, an intermediate light receiver element 3 for receiving light emitted by the light source 1, and a lower solar cell 2 for converting the radiant energy of the light conducted from the light receiver element 3 into an electric power. The electric power, as stated above, a portion thereof is supplied to the light source 1 for continuous illumination while cutting off the external power source for forming an everlasting power generation and a remained portion thereof is supplied to the perpetual battery 4 as a source of eternal power supply.

While the invention has been described by means of specific embodiments, numerous modifications and variations could be made thereto by those skilled in the art without departing from the scope and spirit of the invention set forth in the claims.

What is claimed is:

1. A method for supplying eternal electricity comprising the steps of:
(a) activating a light source by an external power source for impinging light on a solar cell so as to convert the radiant energy of the light into an electric power;
(b) supplying a portion of the electric power to the light source for continuous illumination while cutting off the external power source for forming an everlasting power generation; and
(c) supplying a remained portion of the electric power to a perpetual battery as a source of eternal power supply.

2. The method of claim 1, wherein the light source is one of incandescent lamp, electroluminescent lamp, and light-emitting diode (LED).
